(19) United States
(12) Patent Application Publication
(10) Pub. No.: US 2026/0277468 A1
(43) Pub. Date: Sep. 17, 2026

(54) FACTORY AND FIELD STATES FOR MEMORY SYSTEMS

(71) Applicant: Micron Technology, Inc., Boise, ID (US)

(72) Inventors: Luca Porzio, Casalnuovo (NA) (IT); Jonathan S. Parry, Boise, ID (US); Giuseppe Cariello, Boise, ID (US); Christian M. Gyllenskog, Meridian, ID (US); Xiangang Luo, Fremont, CA (US); David Aaron Palmer, Boise, ID (US)

(21) Appl. No.: 19/566,478

(22) Filed: Mar. 13, 2026

Related U.S. Application Data
(60) Provisional application No. 63/773,338, filed on Mar. 17, 2025.

(51) Int. Cl. G06F 3/06

(52) U.S. Cl. CPC G06F 3/0655; G06F 3/0604; G06F 3/0673

(57) ABSTRACT

Methods, systems, and devices for factory and field states for memory systems are described. When a memory system enters a factory setting, the memory system may be configured to store a first value to one or more first one-time-programmable (OTP) memory elements of the memory system. In response to the one or more first OTP memory elements indicating the first value, the memory system may enable access to one or more operations of the memory system associated with a first operation state. Prior to exiting the factory setting, the memory system may be configured to store a second value to one or more second OTP memory elements of the memory system. In response to the one or more second OTP memory elements indicating the second value, the memory system may disable access to the one or more operations associated with the first operation state.

### CROSS REFERENCE

The present Application for Patent claims priority to U.S. Patent Application No. 63/773,338 by Porzio et al., entitled “FACTORY AND FIELD STATES FOR MEMORY SYSTEMS,” filed Mar. 17, 2025, which is assigned to the assignee hereof, and which is expressly incorporated by reference in its entirety herein.

### TECHNICAL FIELD

The following relates to one or more systems for memory, including factory and field states for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports factory and field states for memory systems in accordance with examples as disclosed herein.

FIG. 2 shows a flowchart illustrating aspects of an operating state configuration that supports factory and field states for memory systems in accordance with examples as disclosed herein.

FIG. 3 shows a block diagram of a memory system that supports factory and field states for memory systems in accordance with examples as disclosed herein.

FIG. 4 shows a flowchart illustrating a process or processes that support factory and field states for memory systems in accordance with examples as disclosed herein.

### DETAILED DESCRIPTION

Some systems may be configured to perform operations that are intended for implementation in a factory setting (e.g., in accordance with a factor state, prior to deployment in a field setting, such as a customer implementation). For example, a memory system may be capable of performing certain operations to improve some factory steps (e.g., during manufacturing, assembly, testing, simulation). Such operations may include a faster program mode, a special self-test mode, or other factory-specific features. However, if a memory system allows such operations in a field setting (e.g., outside of factory use), the memory system may be more vulnerable to operational issues, reduced robustness, or security issues (e.g., denial of services, system failures). Allowing factory-specific operations in a field setting may therefore result in decreased performance or damage to the memory system, diminishing the user experience.

In accordance with aspects disclosed herein, a memory system may be configured to support disabling some operations and features that are intended for factory use and not for field use (e.g., in accordance with a functional lockout). For example, in response to a memory system entering a factory setting, the memory system may be configured to store (e.g., write, program, indicate) a first value at one or more first one-time-programmable (OTP) memory elements (e.g., fuses, antifuses, e-fuses) of the memory system. The first value may correspond to a first operation state (e.g., a factory state). In response to the one or more first OTP elements indicating the first value, the memory system may enable access to one or more operations of the memory system associated with the first operation state. Prior to exiting the factory setting, the memory system may be configured to store a second value at one or more second OTP elements (e.g., fuses, antifuses) of the memory system. The second value may correspond to a second operation state (e.g., a field state). In response to the one or more second OTP elements indicating the second value, the memory system may disable access to the one or more operations associated with the first operation state. Accordingly, the memory system may support one-way transitions to a factory state, from a factory state to a field state, or both such that operations intended for factory use may be prohibited after the memory system leaves a factory setting (or a related manufacturing setting), among other state switching events.

In addition to applicability in memory systems described herein, techniques for factory and field states for memory systems may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by adding additional measures for verifying whether a device may use operations intended for factory use. This may prevent or mitigate unauthorized use of relatively high-risk operations and may mitigate misuse of factory commands in a field setting, among other benefits. Implementing the techniques described herein may also improve the performance of electronic devices by allowing such devices to perform additional operations in a factory setting, which may increase testing efficiency and accuracy and improve manufacturing processes for memory devices, among other benefits.

Features of the disclosure are illustrated and described in the context of systems, devices, and circuits. Features of the disclosure are further illustrated and described in the context of an operation state configuration and flowcharts.

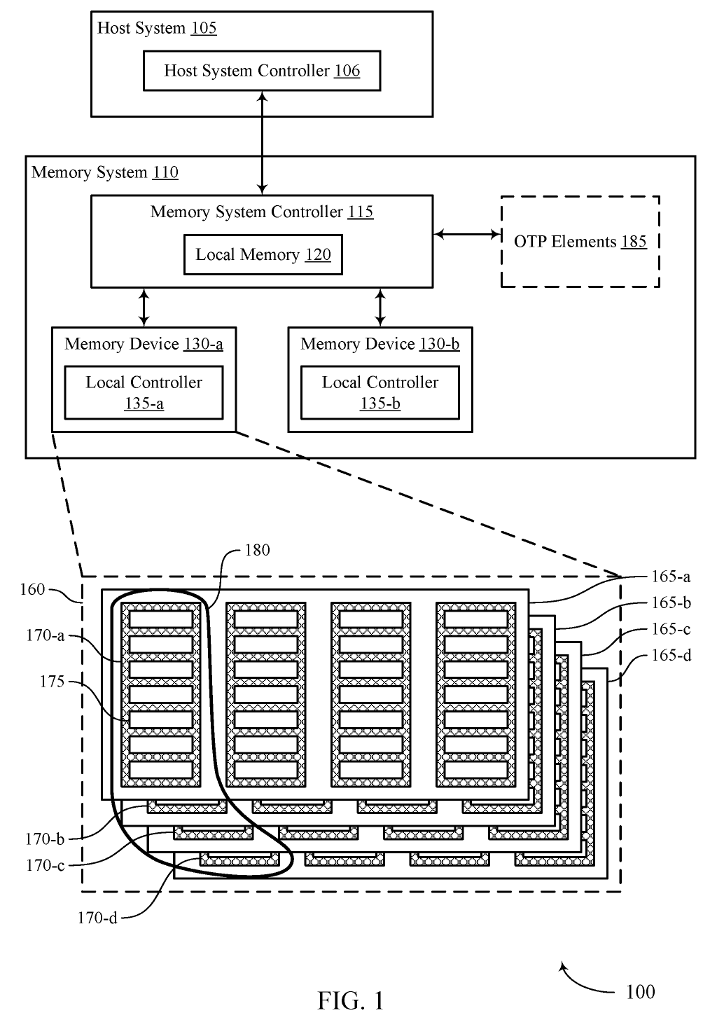

FIG. 1 shows an example of a system 100 that supports factory and field states for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

A memory system 110 may be capable of performing certain operations to improve some factory steps, such as during manufacturing, assembly, testing, simulation, or other steps. Such operations may include a faster program mode, a special self-test mode, or other factory-specific features. However, if a memory system 110 allows such operations in a field setting (e.g., outside of factory use), the memory system 110 may be more vulnerable to operational issues, reduced robustness, or security issues (e.g., denial of services, system failures). Allowing factory-specific operations in a field setting may therefore result in decreased performance or damage to the memory system 110, diminishing the user experience.

In accordance with aspects disclosed herein, a memory system 110 may be configured to support disabling some operations and features that are intended for factory use and not for field use (e.g., in accordance with a functional lockout). For example, in response to a memory system 110 entering a factory setting, the memory system 110 may be configured to store (e.g., write, program, indicate) a first value at one or more first OTP elements 185 (e.g., OTP memory elements, fuses, antifuses, e-fuses). The first value may correspond to a first operation state (e.g., a factory state). In response to the one or more first OTP elements 185 indicating the first value, the memory system 110 (e.g., the memory system controller 115, a local controller 135, or a combination thereof) may enable access to one or more operations of the memory system 110 associated with the first operation state. Prior to exiting the factory setting, the memory system 110 may be configured to store a second value at one or more second OTP elements 185. The second value may correspond to a second operation state (e.g., a field state). In response to the one or more second OTP elements 185 indicating the second value, the memory system 110 may disable access to the one or more operations associated with the first operation state. Accordingly, the memory system 110 may support one-way transitions to a factory state, from a factory state to a field state, or both such that operations intended for factory use may be prohibited after the memory system leaves a factory setting (or a related manufacturing setting), among other state switching events.

As described herein, the OTP elements 185 may indicate a descriptor (e.g., a factory state descriptor or “bDeviceFactoryState”) for a state of the memory system 110 (e.g., a factory state or a field state). The descriptor may mark whether a device (e.g., the memory system 110, a memory system controller 115, one or more memory devices 130) is used for factory usage models or on-field usage models. The descriptor may support a single direction transitioning scheme. That is, the memory system 110, or a component thereof, may transition from the factory state to the field state but, in some implementations, may not transition back to the factory state. An attempt to violate such a transition sequence may result in an error, and the attempt may be rejected by the memory system 110, or component thereof. Accordingly, the memory system 110 may provide protection against high-risk operations in a field setting. While the memory system 110 operates in the factory state, some features may be allowed or prevented in accordance with a usage expectation in a factory setting or a field setting. Although OTP elements 185 are illustrated as a separate component, in various examples, OTP elements 185 in accordance with the described techniques may be included in a memory system controller 115 (e.g., included in local memory 120), outside a memory system controller 115, included in a memory device 130 (e.g., included in a local controller 135), or any combination thereof.

As described herein, a memory system 110 may enable or disable operations associated with a factory state via one or more methods, processes, or procedures. For example, a memory system 110 may control access to an operation depending on a state of the memory system 110. The memory system 110 may be configured to allow performing the operation if one or more of the OTP elements 185 indicate that the memory system 110 is in the factory state. If the one or more of the OTP elements 185 do not indicate the factory state, or if one or more other OTP elements 185 indicate another state (e.g., a field state), the memory system 110 may not allow (e.g., may prevent) performing the operation. In some cases, access to the operation may be provided if the memory system 110 is in the factory state and if another memory element (e.g., of the OTP elements 185, different from the OTP elements 185) associated with the operation indicates that the operation is accessible. Thus, the memory system 110 may provide access to operations that have been enabled and may remove access to operations that have been disabled.

In some implementations, the memory system 110 may enable an operation by writing instructions for the operation in one or more memories of the memory system 110. Similarly, the memory system 110 may disable the operation by prohibiting a write of these instructions. In another example, one or more memory elements of the memory system 110 (e.g., of the OTP elements 185, different from the OTP elements 185) may indicate a key (e.g., a cryptographic key) if the memory system 110 is in the factory state. The memory system 110 may obtain the key by reading the one or more memory elements, which may indicate that the memory system 110 is to operate in the factory state. In some cases, the memory system 110 may apply the key to enable an operation associated with the factory state. That is, the operation may be executed given a correct key (e.g., value) for the operation. If the memory system 110 is not in the factory state, the operation may be disabled (e.g., since the memory system 110 may be unable to obtain the key).

The system 100 may include any quantity of non-transitory computer readable media that support factory and field states for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

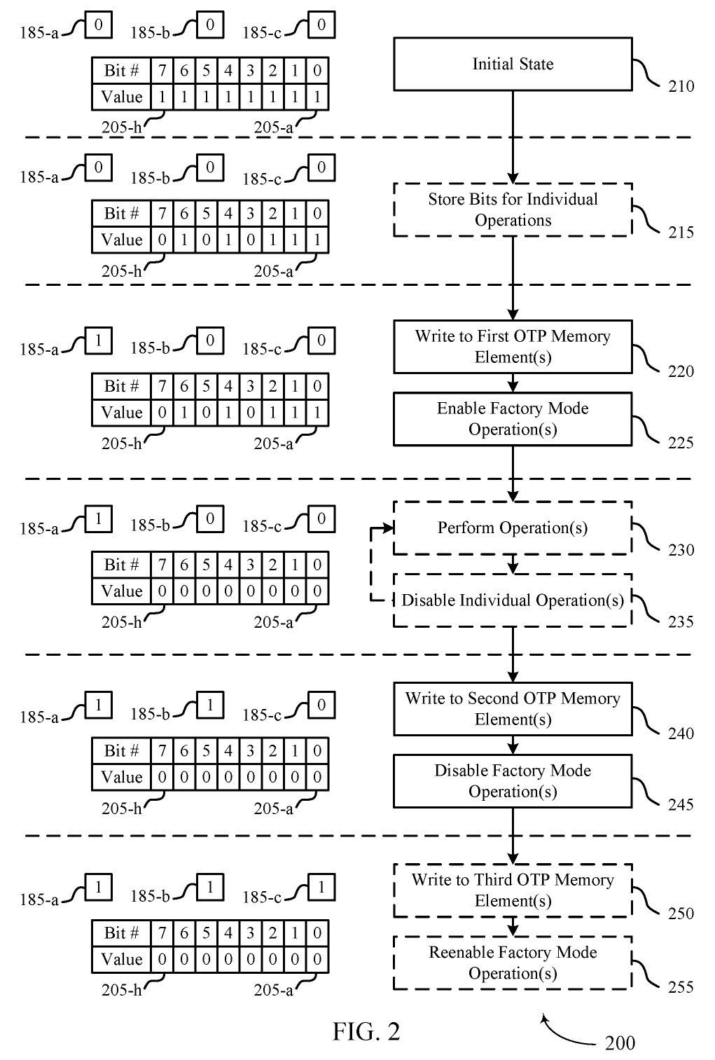

FIG. 2 shows flowchart illustrating aspects of an operation state configuration 200 that supports factory and field states for memory systems in accordance with examples as disclosed herein. In some cases, the operation state configuration 200 may implement or be implemented by aspects of the system 100. In some implementations, a memory system 110 (e.g., a memory system controller 115, one or more local controllers 135, or a combination thereof) may perform a set of one or more steps or procedures as illustrated by the operation state configuration 200. For example, the operation state configuration 200 illustrates procedures which the memory system 110 may perform (e.g., as shown by the operations along the right side of FIG. 2). In some examples, the memory system 110 may be a universal flash storage (UFS) device, a managed NAND device, among other examples.

Aspects of the operation state configuration 200 may be implemented by one or more controllers, among other components. Additionally, or alternatively, aspects of the operation state configuration 200 may be implemented as instructions stored in one or more memories (e.g., firmware stored in one or more memories coupled with a memory system controller 115). For example, the instructions, when executed by one or more controllers (e.g., a memory system controller 115, one or more local controllers 135, or a combination thereof), may cause the one or more controllers (or a device or a system) to perform the operations of the operation state configuration 200. Each procedure (e.g., step) of the operation state configuration 200 also includes an accompanying illustration of a memory structure storing values in accordance with (e.g., in response to, accompanying) the corresponding procedure.

The memory structure (e.g., accompanying each procedure or step) may include one or more OTP elements 185 (e.g., OTP element 185-a, OTP element 185-b, and OTP element 185-c) and, in some examples, memory elements 205 (e.g., a set of memory elements 205-a through 205-h, included in OTP elements 185, different than OTP elements 185). In some other examples, memory elements 205 may be omitted. Each OTP element 185 and each memory element 205 may store a bit value (e.g., a ‘1’ or a ‘0’). In some examples, writing a bit value to an OTP element 185 may include setting (e.g., blowing) a fuse or antifuse associated with the memory system 110. The memory elements 205 may be included in a register and, as a set, may support storing multiple bits (e.g., in accordance with a multi-bit register, such as a 32-bit register).

At 210, the operation state configuration 200 may include an initial state. For example, at 210, the memory system 110 may operate in accordance with the initial state (e.g., with respect to OTP elements 185 and memory elements 205). In the initial state of 210, each of the OTP elements 185 may indicate a first initial value (e.g., an unwritten state, a bit value of ‘0’). In some cases, each of the memory elements 205 may indicate a respective second initial value (e.g., a bit value of ‘1’ or a bit value of ‘0’). The second initial value may be in accordance with an implementation of the set of memory elements 205. For example, the respective second initial value may whether a corresponding operation of one or more operations is enabled for the memory system 110 (e.g., an operation may be enabled or disabled based on a value of a respective memory element 205). In some examples, a memory element 205 may be implemented as an OTP element 185, and an unwritten state of the memory element 205 (e.g., a value of 1) may enable a respective operation, whereas a written state (e.g., a blown fuse, a value of 0) may disable the respective operation).

Prior to entering a factory state or a field state, the memory system 110 may operate in accordance with the initial state of 210. In accordance with the initial state, the memory system 110 may perform operations that are associated with the initial state and that are enabled for such a state. For example, prior to entering the factory state, the memory system 110 may perform operations associated with a field state (e.g., operations which are permitted outside a factory setting). In some examples, the initial state of 210 may be associated with the field state as described herein (e.g., the same as or similar to the field state). In some implementations, the initial state of 210 may be omitted. In such cases, at 210, the memory system 110 may be operating in accordance with a factory state (e.g., the memory system 110 may begin operation in the factory state, as a default).

At 215, the operation state configuration 200 may include storing (e.g., writing) a respective bit value to one or more of the memory elements 205 (e.g., each corresponding to a respective set of one or more operations or capabilities of the memory system 110). The set of memory elements 205 may indicate a descriptor (e.g., an extended feature support descriptor) associated with a bitmap of features or operations that may be supported by the memory system 110. For example, each bit value of the memory elements 205 may indicate whether a respective operation of the one or more operations (e.g., associated with the set of memory elements 205) is enabled in accordance with a first operation state of the memory system (e.g., the “factory state”). A first bit value (e.g., ‘1’) may indicate that the respective operation is enabled, and a second bit value (e.g., ‘0’) may indicate that the respective operation is disabled. As described herein, an operation state (e.g., the first operation state) may refer to a mode in which the memory system 110 may be configured to perform a corresponding set of operations and to operate in accordance with a corresponding behavior.

Accordingly, one or more operations may be enabled in the first operation state in accordance with the respective bit values of memory elements 205. For example, in some cases, the memory system 110 may store a first bit value to a subset of the set of memory elements 205 (e.g., storing a logic 1 to bits 6, 4, 2, 1, and 0). Additionally, or alternatively, the memory system 110 may store a second bit value to another subset of the set of memory elements 205 (e.g., storing a logic 0 to bits 7, 5, and 3). In some implementations, the set of memory elements 205 may include OTP elements. Accordingly, in some cases, the memory system 110 may refrain from storing the second bit value to the second subset of the set of memory elements 205. For example, each OTP element may begin at a state corresponding to the first bit value, and the memory system 110 may store the second bit value at one or more of the set of memory elements 205 to disable corresponding operation(s). In some implementations (e.g., if the set of memory elements 205 are OTP elements), disabling features or operations may be irreversible (e.g., after a bit in the bitmap is reset, it may not be set again).

At 220, the operation state configuration 200 may include writing a first value to one or more first OTP elements 185 (e.g., storing the first value at the one or more first OTP elements 185). For example, the memory system 110 (e.g., using a memory system controller 115, a local controller 135, or a combination thereof) may write the first value (e.g., a value of ‘1’ as shown) to the OTP element 185-a. The first value at the OTP element 185-a may correspond to or may indicate the first operation state of the memory system 110 (e.g., the “factory state”). In some cases, the first value stored at OTP element 185-a may indicate that the memory system 110 is enabled to operate in accordance with the first operation state.

At 225, the operation state configuration 200 may include enabling factory mode operations. For example, the memory system 110 (e.g., a memory system controller 115, one or more local controllers 135, or a combination thereof) may enable the one or more operations associated with the first operation state in accordance with the OTP element 185-a indicating the first value (e.g., the one or more operations may be disabled until OTP element 185-a indicates the first value). The one or more operations may be associated with factory or manufacturing procedures, and may include one or more device self-test operations (e.g., built-in self-test (BIST) operations), one or more fast-programming operations (e.g., high-speed programming operations, operations for programming on multiple pages 175 concurrently), one or more reduced security operations, one or more custom SLC operations, or a combination thereof.

In some cases, the memory system 110 may enable at least some operations in further accordance with the respective bit values stored at the set of memory elements 205. The memory system 110 may enable a first subset of the one or more operations (e.g., before writing to one or more second OTP elements, such as OTP element 185-b) in accordance with respective memory elements 205 associated with the first subset of the one or more operations indicating the first bit value. For example, if a first memory element 205 (e.g., bit 6) of the set of memory elements 205 indicates the first bit value (e.g., a logic 1), the memory system 110 may enable one or more operations associated with the first memory element (e.g., associated with bit 6). The memory system 110 may enable one or more other operations in accordance with other memory elements of the set of memory elements 205 indicating the first bit value (e.g., enabling operations associated with bits 4, 2, 1, and 0).

In some implementations, the memory system 110 may store the second bit value to a respective memory element 205 associated with one of the first subset of the one or more operations (e.g., bit 7). Then, the memory system 110 may disable the one or more operations in direct response to storing the second bit value to the respective memory element 205 associated with one of the first subset of the one or more operations. Additionally, or alternatively, the memory system 110 may disable a second subset of the one or more operations, before writing to the one or more second OTP elements (e.g., before writing OTP element 185-b), in accordance with respective memory elements 205 associated with the second subset of the one or more operations indicating the second bit value (e.g., ‘0’).

As described herein, the set of memory elements 205 may indicate a descriptor (e.g., a “factory extended feature descriptor”) that includes a bitmap of features or operations which may be supported or enabled by the memory system 110. For example, bit 0 may indicate whether a fast-programming factory mode is available, bit 1 may indicate whether a special device self-test procedure is available, and bit 2 may indicate whether a custom SLC mode is available. In such an example, a descriptor with a value of ‘101’ (e.g., ‘5’) may indicate that the memory system 110 may use the fast programming factory mode and the custom SLC mode, but may not use the device self-test procedure. Accordingly, in accordance with the first operation state (e.g., the factory state), the memory system 110 may enable or disable specific operations and features such as a fast-programming mode, a self-test procedure, a custom SLC mode, enhanced security operations, reduced security operations, writing to read-only memory, factory programming operations, one or more enhanced testing or simulation procedures, or any combination thereof.

At 230, the operation state configuration 200 may include performing one or more operations while operating in the first operation state. For example, the memory system 110 (e.g., the memory system controller, one or more local controllers 135, or a combination thereof) may perform operations (e.g., features) associated with the first operation state (e.g., the one or more operations). In some examples, at 230, the memory system 110 may perform a first operation of the one or more operations (e.g., as a one-shot operation, as a one-shot command) and, at 235, the memory system 110 may disable the first operation. For example, the memory system 110 may disable the first operation in response to performing the operation (e.g., by writing the second bit value to the memory element 205 corresponding to the operation). The memory system 110 may perform and subsequently disable future use of each operation of the one or more operations accordingly. In some cases, the memory system 110 may store the second bit value to each memory element 205 of the set of memory elements 205 (e.g., each memory element that indicates the first bit value) in response to performing a respective operation corresponding to each memory element. Accordingly, in some implementations, the memory system 110 may disable any future usage of an operation in response to performing the operation and, in some examples, detecting a successful result of the operation. For example, the memory system 110 may disable operations which are associated with improving failure screening in a factory setting (e.g., operations that may be expected to be performed a single time).

At 240, the operation state configuration 200 may include writing a second value to one or more second OTP elements 185 (e.g., storing the second value at the one or more second OTP elements 185, different than the one or more first OTP elements written at 220). For example, the memory system 110 (e.g., the memory system controller, one or more local controllers 135, or a combination thereof) may write the second value (e.g., a logic 1) to the OTP element 185-b. The second value at the OTP element 185-b may correspond to or may indicate the second operation state of the memory system 110 (e.g., a “field” state, an operation state to be used outside a factory setting). In some cases, the second value stored at OTP element 185-b may indicate that the memory system 110 is enabled to operate in accordance with the second operation state, and not enabled to operate in accordance with the first operation state. For example, the second value at the OTP element 185-b may supersede the first value at the OTP element 185-a. In some examples, the second value at the OTP element 185-b may be a same value as the first value at the OTP element 185-a (e.g., both may be a “fuse blown” state).

At 245, the operation state configuration 200 may include disabling factory mode operations. For example, the memory system 110 (e.g., a memory system controller 115, one or more local controllers 135, or a combination thereof) may disable the one or more operations associated with the first operation state in accordance with the OTP element 185-b indicating the second value (e.g., the one or more operations may be enabled until OTP element 185-b indicates the second value).

Disabling the one or more operations (e.g., and entering the second operation state) may be in response to one or more conditions being satisfied. For example, the memory system 110 may write a replay protected memory block (RPMB) master key to one or more memory elements of the memory system 110 (e.g., an RPMB of a memory device 130, an RPMB of a memory system controller 115). In response to writing the RPMB master key, the memory system 110 may write the second value to the OTP element 185-b (e.g., to disable the one or more operations). If the memory system 110 is programming the RPMB master key, the memory system 110 may expect that most, if not all of a factory programming process is complete. Accordingly, the memory system 110 may determine (e.g., assume, infer) that factory features or operations are no longer to be used, and write the second value to the OTP element 185-b.

Additionally, or alternatively, the memory system 110 may monitor an amount of data written to the memory system 110 (e.g., a total bytes written (TBW) value). In response to the amount of data written to the memory system 110 satisfying (e.g., exceeding) a threshold amount of data (e.g., a TBW threshold), the memory system 110 may write the second value to the OTP element 185-b (e.g., to disable the one or more operations). For example, the memory system 110 may detect a quantity of writes that satisfies a multiple of a density of the memory system 110 (e.g., 10 times the density of the memory system 110). In response, the memory system 110 may determine that it is no longer in a factory setting (e.g., a factory context), and may disable the one or more operations (e.g., the factory features).

In some implementations, the memory system 110 may also support a reenabling of a factory state (e.g., due to one or more error conditions, to support a test condition, to support a reconfiguration), which may be cryptographically protected. Accordingly, in some implementations, the memory system 110 may reenter the first operation state in accordance with a value of one or more third OTP elements 185 (e.g., superseding values stored at the OTP elements 185-a and 185-b). For example, the memory system 110 may receive, from a host system, a command that includes a cryptographic signature associated with reenabling the one or more operations (e.g., a vendor unique (VU) command corresponding to one or more vendors). The cryptographic signature may include a value or a key associated with a mathematical algorithm to verify the authenticity and the integrity of the command. In response to the command, at 250, the operation state configuration 200 may include writing a third value to one or more third OTP elements 185 (e.g., storing the third value at the one or more third OTP elements 185, different than the one or more first OTP elements written at 220 and different than the one or more second OTP elements 185 written at 240) in accordance with the command including the cryptographic signature. For example, the memory system 110 (e.g., using a memory system controller 115, a local controller 135, or a combination thereof) may write the third value (e.g., a value of ‘1’ as shown) to the OTP element 185-c. The third value at the OTP element 185-c may correspond to or may indicate the first operation state of the memory system 110 (e.g., the “factory” state). In some cases, the third value stored at OTP element 185-c may indicate that the memory system 110 is enabled to operate in accordance with the first operation state. For example, the third value at the OTP element 185-c may supersede the second value at the OTP element 185-b. In some examples, the third value at the OTP element 185-c may be a same value as the first value at the OTP element 185-b and the second value at the OTP element 185-c (e.g., all may be a “fuse blown” state).

At 255, the operation state configuration 200 may include re-enabling factory mode operations. For example, the memory system 110 (e.g., a memory system controller 115, one or more local controllers 135, or a combination thereof) may re-enable the one or more operations associated with the first operation state in accordance with the OTP element 185-c indicating the third value. Although three OTP elements 185 are shown, a memory system 110 may include any quantity of OTP elements 185 that support any quantity of transitions to and from a factory state, and repeated enabling, disabling or both may involve a cryptographic protection.

Thus, in accordance with these and other examples, a memory system 100 may be configured to support disabling some operations and features that are intended for factory use and not for field use (e.g., in accordance with a functional lockout). For example, the memory system 110 may be configured to store a value at one or more first OTP elements 185 that corresponds to a first operation state. In response, the memory system 110 may enable access to one or more operations of the memory system 110 associated with the first operation state. The memory system 110 may also be configured to store a value at one or more second OTP elements 185 that corresponds to a second operation state. In response, the memory system 110 may disable access to one or more operations of the memory system 110 associated with the first operation state. Accordingly, the memory system 110 may support any quantity of one-way transitions to a first state (e.g., a factory state), from the first state to a second state (e.g., a field state), or both such that operations intended for a given state may be permitted or prohibited selectively, in accordance with successive writing to different OTP elements 185. Such techniques may may improve the security of a memory system 110 by adding additional measures for verifying whether a device may use operations intended for factory use, by preventing or mitigating unauthorized use of relatively high-risk operations or misuse of factory commands in a field setting, among other benefits. Such techniques may also improve the performance of a memory system 110 by supporting additional operations in a factory setting, which may increase testing efficiency and accuracy and improve manufacturing processes for memory systems 110, among other benefits.

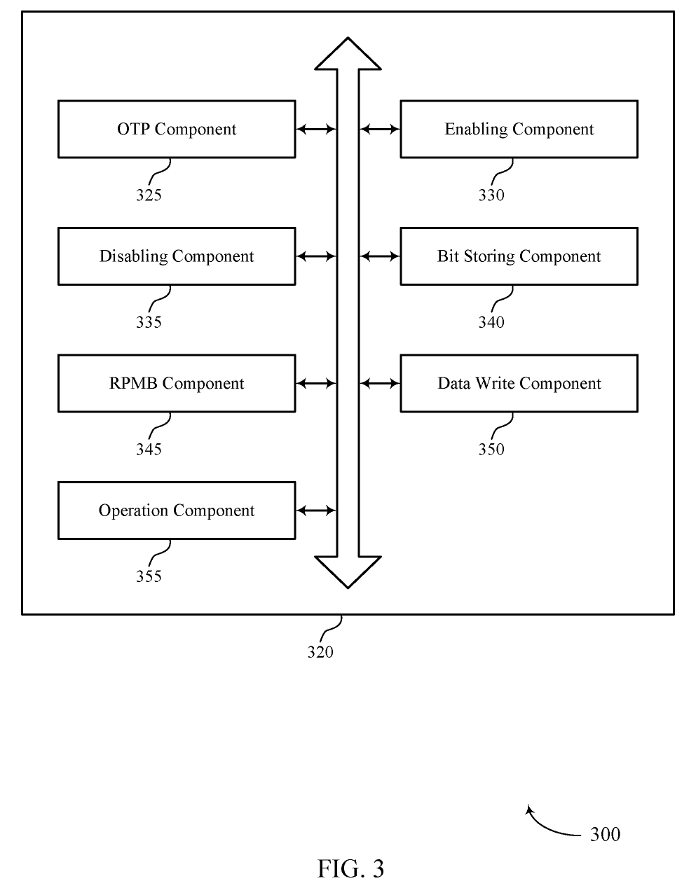

FIG. 3 shows a block diagram 300 of a memory system 320 that supports factory and field states for memory systems in accordance with examples as disclosed herein. The memory system 320 may be an example of aspects of a memory system as described with reference to FIGS. 1 through 2. The memory system 320, or various components thereof, may be an example of means for performing various aspects of factory and field states for memory systems as described herein. For example, the memory system 320 may include a OTP component 325, an enabling component 330, a disabling component 335, a bit storing component 340, an RPMB component 345, a data write component 350, an operation component 355, or any combination thereof. Each of these components, or components of subcomponents thereof (e.g., one or more processors, one or more memories), may communicate, directly or indirectly, with one another (e.g., via one or more buses).

The OTP component 325 may be configured as or otherwise support a means for writing, to one or more first OTP elements of the memory system 320, a first value corresponding to a first operation state of the memory system 320. The enabling component 330 may be configured as or otherwise support a means for enabling one or more operations of the memory system 320 associated with the first operation state in accordance with the one or more first OTP elements indicating the first value. In some examples, the OTP component 325 may be configured as or otherwise support a means for writing, to one or more second OTP elements of the memory system 320, different than the one or more first OTP elements, a second value corresponding to a second operation state of the memory system 320. The disabling component 335 may be configured as or otherwise support a means for disabling the one or more operations associated with the first operation state in accordance with the one or more second OTP elements indicating the second value.

In some examples, the bit storing component 340 may be configured as or otherwise support a means for storing, at each memory element of a plurality of memory elements, a respective bit value that indicates whether a respective operation of the one or more operations is enabled in accordance with the first operation state, a first bit value indicating that the respective operation is enabled, and a second bit value indicating that the respective operation is disabled, where enabling the one or more operations is in accordance with the respective bit values.

In some examples, the enabling component 330 may be configured as or otherwise support a means for enabling a first subset of the one or more operations, before the writing to the one or more second OTP elements, in accordance with respective memory elements associated with the first subset of the one or more operations indicating the first bit value.

In some examples, the bit storing component 340 may be configured as or otherwise support a means for storing the second bit value to a respective memory element associated with one of the first subset of the one or more operations, the respective memory element including a third OTP element. In some examples, the disabling component 335 may be configured as or otherwise support a means for disabling the one of the one or more operations based at least in part on storing the second bit value to the respective memory element associated with one of the first subset of the one or more operations.

In some examples, the disabling component 335 may be configured as or otherwise support a means for disabling a second subset of the one or more operations, before the writing to the one or more second OTP elements, in accordance with respective memory elements associated with the second subset of the one or more operations indicating the second bit value.

In some examples, the RPMB component 345 may be configured as or otherwise support a means for writing an RPMB master key to one or more memory elements of the memory system 320, where writing the second value to the one or more second OTP elements is in response to writing the RPMB master key.

In some examples, the data write component 350 may be configured as or otherwise support a means for monitoring an amount of data written to the memory system 320, where writing the second value to the one or more second OTP elements is in response to the amount of data written to the memory system 320 satisfying a threshold.

In some examples, the operation component 355 may be configured as or otherwise support a means for performing at least one of the one or more operations in accordance with the one or more first OTP elements indicating the first value and in accordance with the first operation state.

In some examples, the operation component 355 may be configured as or otherwise support a means for performing an operation of the one or more operations. In some examples, the disabling component 335 may be configured as or otherwise support a means for disabling the operation in response to performing the operation of the one or more operations.

In some examples, the OTP component 325 may be configured as or otherwise support a means for writing, in accordance with a command that includes a cryptographic signature associated with reenabling the one or more operations, a third value corresponding to the first operation state to one or more third OTP elements of the memory system 320. In some examples, the enabling component 330 may be configured as or otherwise support a means for enabling the one or more operations in accordance with the one or more third OTP elements indicating the third value.

In some examples, the one or more operations include one or more device self-test operations, one or more fast-programming operations, one or more reduced security operations, one or more custom single level cell operations, or a combination thereof.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

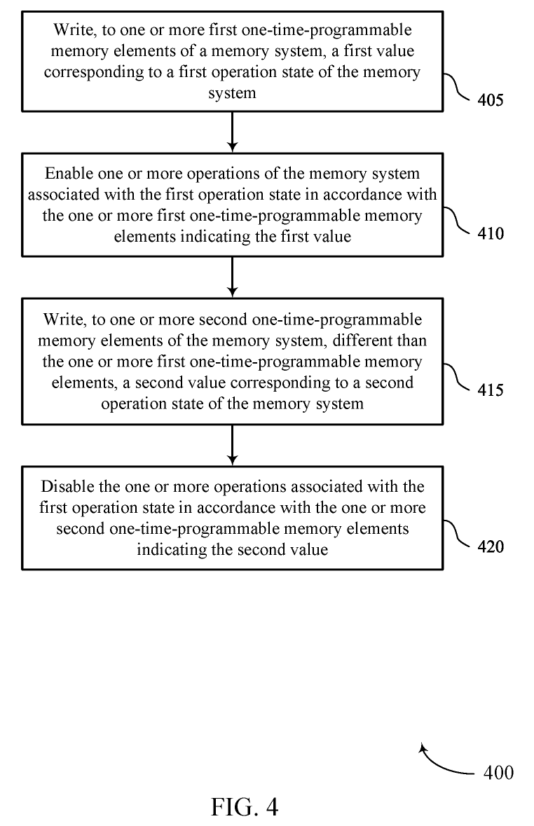

FIG. 4 shows a flowchart illustrating a process 400 that supports factory and field states for memory systems in accordance with examples as disclosed herein. The operations of process 400 may be implemented by a memory system or its components as described herein. For example, the operations of process 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the process may include writing, to one or more first OTP elements of a memory system, a first value corresponding to a first operation state of the memory system. In some examples, aspects of the operations of 405 may be performed by an OTP component 325 as described with reference to FIG. 3.

At 410, the process may include enabling one or more operations of the memory system associated with the first operation state in accordance with the one or more first OTP elements indicating the first value. In some examples, aspects of the operations of 410 may be performed by an enabling component 330 as described with reference to FIG. 3.

At 415, the process may include writing, to one or more second OTP elements of the memory system, different than the one or more first OTP elements, a second value corresponding to a second operation state of the memory system. In some examples, aspects of the operations of 415 may be performed by an OTP component 325 as described with reference to FIG. 3.

At 420, the process may include disabling the one or more operations associated with the first operation state in accordance with the one or more second OTP elements indicating the second value. In some examples, aspects of the operations of 420 may be performed by a disabling component 335 as described with reference to FIG. 3.

In some examples, an apparatus as described herein may perform a process or processes, such as the process 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing, to one or more first OTP elements of a memory system, a first value corresponding to a first operation state of the memory system; enabling one or more operations of the memory system associated with the first operation state in accordance with the one or more first OTP elements indicating the first value; writing, to one or more second OTP elements of the memory system, different than the one or more first OTP elements, a second value corresponding to a second operation state of the memory system; and disabling the one or more operations associated with the first operation state in accordance with the one or more second OTP elements indicating the second value.

Aspect 2: The method, apparatus, or non-transitory computer-readable medium of aspect 1, further including operations, features, circuitry, logic, means, or instructions, or any combination thereof for storing, at each memory element of a plurality of memory elements, a respective bit value that indicates whether a respective operation of the one or more operations is enabled in accordance with the first operation state, a first bit value indicating that the respective operation is enabled, and a second bit value indicating that the respective operation is disabled, where enabling the one or more operations is in accordance with the respective bit values.

Aspect 3: The method, apparatus, or non-transitory computer-readable medium of aspect 2, further including operations, features, circuitry, logic, means, or instructions, or any combination thereof for enabling a first subset of the one or more operations, before the writing to the one or more second OTP elements, in accordance with respective memory elements associated with the first subset of the one or more operations indicating the first bit value.

Aspect 4: The method, apparatus, or non-transitory computer-readable medium of aspect 3, further including operations, features, circuitry, logic, means, or instructions, or any combination thereof for storing the second bit value to a respective memory element associated with one of the first subset of the one or more operations, the respective memory element including a third OTP element and disabling the one of the one or more operations based at least in part on storing the second bit value to the respective memory element associated with one of the first subset of the one or more operations.

Aspect 5: The method, apparatus, or non-transitory computer-readable medium of any of aspects 2 through 4, further including operations, features, circuitry, logic, means, or instructions, or any combination thereof for disabling a second subset of the one or more operations, before the writing to the one or more second OTP elements, in accordance with respective memory elements associated with the second subset of the one or more operations indicating the second bit value.

Aspect 6: The method, apparatus, or non-transitory computer-readable medium of any of aspects 1 through 5, further including operations, features, circuitry, logic, means, or instructions, or any combination thereof for writing an RPMB master key to one or more memory elements of the memory system, where writing the second value to the one or more second OTP elements is in response to writing the RPMB master key.

Aspect 7: The method, apparatus, or non-transitory computer-readable medium of any of aspects 1 through 6, further including operations, features, circuitry, logic, means, or instructions, or any combination thereof for monitoring an amount of data written to the memory system, where writing the second value to the one or more second OTP elements is in response to the amount of data written to the memory system satisfying a threshold.

Aspect 8: The method, apparatus, or non-transitory computer-readable medium of any of aspects 1 through 7, further including operations, features, circuitry, logic, means, or instructions, or any combination thereof for performing at least one of the one or more operations in accordance with the one or more first OTP elements indicating the first value and in accordance with the first operation state.

Aspect 9: The method, apparatus, or non-transitory computer-readable medium of aspect 8, further including operations, features, circuitry, logic, means, or instructions, or any combination thereof for performing an operation of the one or more operations and disabling the operation in response to performing the operation of the one or more operations.

Aspect 10: The method, apparatus, or non-transitory computer-readable medium of any of aspects 1 through 9, further including operations, features, circuitry, logic, means, or instructions, or any combination thereof for writing, in accordance with a command that includes a cryptographic signature associated with reenabling the one or more operations, a third value corresponding to the first operation state to one or more third OTP elements of the memory system and enabling the one or more operations in accordance with the one or more third OTP elements indicating the third value.

Aspect 11: The method, apparatus, or non-transitory computer-readable medium of any of aspects 1 through 10, where the one or more operations include one or more device self-test operations, one or more fast-programming operations, one or more reduced security operations, one or more custom single level cell operations, or a combination thereof.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 12: A memory system, including: one or more memory devices; a plurality of OTP elements; and processing circuitry coupled with the one or more memory devices and configured to cause the memory system to: enable one or more operations of the memory system in accordance with a first value written to one or more first OTP elements of the plurality of OTP elements; and disable the one or more operations of the memory system in accordance with a second value written to one or more second OTP elements of the plurality of OTP elements.

Aspect 13: The memory system of aspect 12, where the processing circuitry is configured to cause the memory system to: disable the one or more operations of the memory system in accordance with second value written to the one or more second OTP elements irrespective of a value written to the one or more first OTP meory elements.

Aspect 14: The memory system of any of aspects 12 through 13, where the processing circuitry is configured to cause the memory system to: perform at least one of the one or more operations in accordance with the first value being written to the one or more first OTP elements and the second value not being written to the one or more second OTP elements.

Aspect 15: The memory system of any of aspects 12 through 14, further including: a plurality of memory elements each configured to store a bit value that indicates whether a respective operation of the one or more operations is enabled.

Aspect 16: The memory system of any of aspects 12 through 15, where, to enable the one or more operations, the processing circuitry is configured to cause the memory system to: modify one or more attributes of the memory system, the one or more attributes including one or more operation timing parameters, one or more error control parameters, one or more access pattern parameters, or a combination thereof.

Aspect 17: The memory system of any of aspects 12 through 16, where the processing circuitry is configured to cause the memory system to: enable the one or more operations of the memory system, irrespective of the second value being written to the one or more second OTP elements, in accordance with a third value being written to one or more third OTP elements of the plurality of OTP elements in response to a command that includes a cryptographic signature.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
write, to one or more first one-time-programmable memory elements of the memory system, a first value corresponding to a first operation state of the memory system;
enable one or more operations of the memory system associated with the first operation state in accordance with the one or more first one-time-programmable memory elements indicating the first value;
write, to one or more second one-time-programmable memory elements of the memory system, different than the one or more first one-time-programmable memory elements, a second value corresponding to a second operation state of the memory system; and
disable the one or more operations associated with the first operation state in accordance with the one or more second one-time-programmable memory elements indicating the second value.

2. The memory system of claim 1, wherein the processing circuitry is further configured to cause the memory system to:
store, at each memory element of a plurality of memory elements, a respective bit value that indicates whether a respective operation of the one or more operations is enabled in accordance with the first operation state, a first bit value indicating that the respective operation is enabled, and a second bit value indicating that the respective operation is disabled, wherein enabling the one or more operations is in accordance with the respective bit values.

3. The memory system of claim 2, wherein the processing circuitry is further configured to cause the memory system to:
enable a first subset of the one or more operations, before the writing to the one or more second one-time-programmable memory elements, in accordance with respective memory elements associated with the first subset of the one or more operations indicating the first bit value.

4. The memory system of claim 3, wherein the processing circuitry is further configured to cause the memory system to:
store the second bit value to a respective memory element associated with one of the first subset of the one or more operations, the respective memory element comprising a third one-time-programmable memory element; and
disable the one of the one or more operations based at least in part on storing the second bit value to the respective memory element associated with one of the first subset of the one or more operations.

5. The memory system of claim 2, wherein the processing circuitry is further configured to cause the memory system to:
disable a second subset of the one or more operations, before the writing to the one or more second one-time-programmable memory elements, in accordance with respective memory elements associated with the second subset of the one or more operations indicating the second bit value.

6. The memory system of claim 1, wherein the processing circuitry is further configured to cause the memory system to:
write a replay protected memory block master key to one or more memory elements of the memory system, wherein writing the second value to the one or more second one-time-programmable memory elements is in response to writing the replay protected memory block master key.

7. The memory system of claim 1, wherein the processing circuitry is further configured to cause the memory system to:
monitor an amount of data written to the memory system, wherein writing the second value to the one or more second one-time-programmable memory elements is in response to the amount of data written to the memory system satisfying a threshold.

8. The memory system of claim 1, wherein the processing circuitry is further configured to cause the memory system to:
perform at least one of the one or more operations in accordance with the one or more first one-time-programmable memory elements indicating the first value and in accordance with the first operation state.

9. The memory system of claim 8, wherein the processing circuitry is further configured to cause the memory system to:
perform an operation of the one or more operations; and
disable the operation in response to performing the operation of the one or more operations.

10. The memory system of claim 1, wherein the processing circuitry is further configured to cause the memory system to:
write, in accordance with a command that includes a cryptographic signature associated with reenabling the one or more operations, a third value corresponding to the first operation state to one or more third one-time-programmable memory elements of the memory system; and
enable the one or more operations in accordance with the one or more third one-time-programmable memory elements indicating the third value.

11. The memory system of claim 1, wherein the one or more operations comprise one or more device self-test operations, one or more fast-programming operations, one or more reduced security operations, one or more custom single level cell operations, or a combination thereof.

12. A non-transitory computer-readable medium storing code comprising instructions which, when executed by one or more processors of a memory system, cause the memory system to:
write, to one or more first one-time-programmable memory elements of a memory system, a first value corresponding to a first operation state of the memory system;
enable one or more operations of the memory system associated with the first operation state in accordance with the one or more first one-time-programmable memory elements indicating the first value;
write, to one or more second one-time-programmable memory elements of the memory system, different than the one or more first one-time-programmable memory elements, a second value corresponding to a second operation state of the memory system; and
disable the one or more operations associated with the first operation state in accordance with the one or more second one-time-programmable memory elements indicating the second value.

13. The non-transitory computer-readable medium of claim 12, wherein the instructions, when executed by the one or more processors of the memory system, further cause the memory system to:
store, at each memory element of a plurality of memory elements, a respective bit value that indicates whether a respective operation of the one or more operations is enabled in accordance with the first operation state, a first bit value indicating that the respective operation is enabled, and a second bit value indicating that the respective operation is disabled, wherein enabling the one or more operations is in accordance with the respective bit values.

14. The non-transitory computer-readable medium of claim 12, wherein the instructions, when executed by the one or more processors of the memory system, further cause the memory system to:
write a replay protected memory block master key to one or more memory elements of the memory system, wherein writing the second value to the one or more second one-time-programmable memory elements is in response to writing the replay protected memory block master key.

15. The non-transitory computer-readable medium of claim 12, wherein the instructions, when executed by the one or more processors of the memory system, further cause the memory system to:
monitor an amount of data written to the memory system, wherein writing the second value to the one or more second one-time-programmable memory elements is in response to the amount of data written to the memory system satisfying a threshold.

16. The non-transitory computer-readable medium of claim 12, wherein the instructions, when executed by the one or more processors of the memory system, further cause the memory system to:
perform at least one of the one or more operations in accordance with the one or more first one-time-programmable memory elements indicating the first value and in accordance with the first operation state.

17. A memory system, comprising:
one or more memory devices;
a plurality of one-time-programmable memory elements; and
processing circuitry coupled with the one or more memory devices and configured to cause the memory system to:
enable one or more operations of the memory system in accordance with a first value written to one or more first one-time-programmable memory elements of the plurality of one-time-programmable memory elements; and
disable the one or more operations of the memory system in accordance with a second value written to one or more second one-time-programmable memory elements of the plurality of one-time-programmable memory elements.

18. The memory system of claim 17, wherein the processing circuitry is configured to cause the memory system to:
disable the one or more operations of the memory system in accordance with second value written to the one or more second one-time-programmable memory elements irrespective of a value written to the one or more first one-time-programmable memory elements.

19. The memory system of claim 17, wherein the processing circuitry is configured to cause the memory system to:
perform at least one of the one or more operations in accordance with the first value being written to the one or more first one-time-programmable memory elements and the second value not being written to the one or more second one-time-programmable memory elements.

20. The memory system of claim 17, further comprising:
a plurality of memory elements each configured to store a bit value that indicates whether a respective operation of the one or more operations is enabled.

21. The memory system of claim 17, wherein, to enable the one or more operations, the processing circuitry is configured to cause the memory system to:
modify one or more attributes of the memory system, the one or more attributes comprising one or more operation timing parameters, one or more error control parameters, one or more access pattern parameters, or a combination thereof.

22. The memory system of claim 17, wherein the processing circuitry is configured to cause the memory system to:
enable the one or more operations of the memory system, irrespective of the second value being written to the one or more second one-time-programmable memory elements, in accordance with a third value being written to one or more third one-time-programmable memory elements of the plurality of one-time-programmable memory elements in response to a command that includes a cryptographic signature.
